(19) United States
(12) Patent Application Publication
(10) Pub. No.: US 2025/0060775 A1
(43) Pub. Date: Feb. 20, 2025

(54) OPTICAL MULTIPLICATION SYSTEM AND OPTICAL MULTIPLICATION METHOD

(71) Applicant: OXFORD UNIVERSITY INNOVATION LIMITED, Oxford (GB)

(72) Inventors: Xianxin Guo, Oxford (GB); Jiawei DAI, Shanghai (CN); James SPALL, Oxford (GB); Alexander LVOVSKY, Oxford (GB)

(21) Appl. No.: 18/708,552

(22) PCT Filed: Oct. 31, 2022
(86) PCT No.: PCT/GB2022/052750

§ 371 Date: May 8, 2024

(30) Foreign Application Priority Data
Nov. 9, 2021 (GB) 2116073.4
Oct. 31, 2022 (WO) PCT/GB2022/052750

(51) Int. Cl. G06E 3/00

(52) U.S. Cl. CPC G06E 3/008; G06E 3/005

(57) ABSTRACT

Systems and methods for optical multiplication are disclosed. In one arrangement, a first modulator comprising rows and columns of first modulator elements is configured to spatially modulate light received from a deflector. The first modulator encodes values of a first matrix. The first matrix defines a plurality of input vectors each corresponding to a respective row of the first matrix. A second modulator spatially modulates light received from the first modulator and encodes values of a second matrix in rows and columns of second modulator elements. A light-summing optical arrangement converges light output from each row of second modulator elements to encode a plurality of output vectors representing the results of vector-matrix multiplication between a respective plurality of the input vectors and the second matrix.

The present disclosure relates to optical multiplication and is particularly applicable to implementing optical vector-matrix multiplication (OVMM) and optical matrix-matrix multiplication (OMMM).

An optical vector-matrix multiplication system is an optical system where the vector and matrix information is stored in optical signals, and the multiplication operation is performed optically. The information is stored and processed in the intensity of light in incoherent systems, and in the electric field amplitude in coherent systems. Vector-matrix multiplication (VMM), or matrix-matrix multiplication as a combination of many VMMs, involves many pairwise products of large arrays of numbers, and summation of these products. VMM is a core operation in many modern computational tasks, ranging from image-processing to machine learning. Due to the parallel nature and superposition property of light, an optical system can process large-scale vector-vector multiplication in parallel in a very short period of time and therefore provides a promising analogue platform to perform fast, parallel and extensive linear algebraic operations in computational problems.

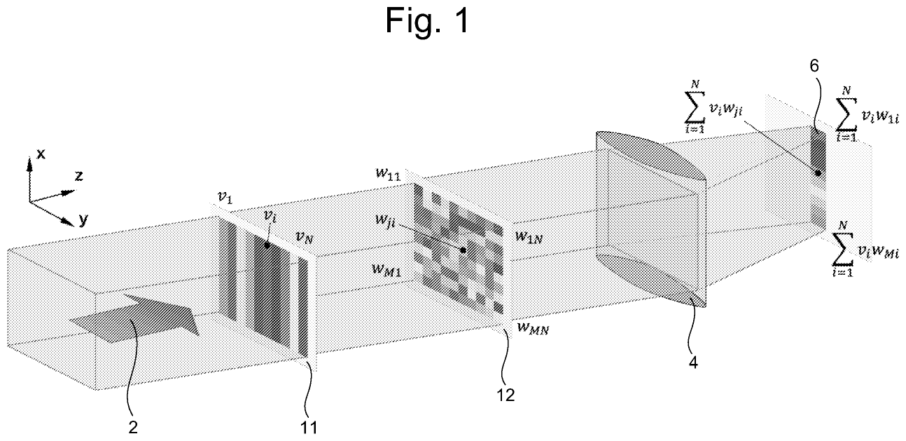

A conceptual schematic of a typical free-space OVMM system is illustrated in FIG. 1. The system implements three functions: 1) encoding vector and matrix information; 2) multiplication of corresponding vector and matrix elements; 3) summation of products along the direction of the vector.

Encoding: The values of vector vᵢ(i=1, 2, . . . , N) and matrix wᵢⱼ(i=1, 2, . . . , N; j=1, 2, . . . M) are encoded in the spatially distributed transmission functions of two spatial light modulators (SLMs) (labelled 11 and 12) capable of arbitrarily modulating the amplitude and phase of the electric field at any transverse position. Incident light is represented by arrow 2. After encoding the vector with the first SLM 11, the beam is uniformly expanded over the direction perpendicular to the vector, in order to be multiplied by each row of the matrix.

Multiplication: After passing through the second SLM 12 encoding matrix elements, the dot products of the expanded vector and the matrix vᵢ×wⱼᵢ are stored in the amplitude (or intensity) of the light over the transverse direction.

Summation: A Fourier transformation (or incoherent summation) is implemented with a cylindrical lens 4 and a slit 6 is used to collect the zero spatial frequency of the light, which is ideally the summation of these products Σᵢ₋₁^{N} vᵢwⱼᵢ. A list of summation of products are given along the slit direction as the final computational result. They can be measured by interference or intensity detection in coherent or incoherent settings.

Although a one-dimensional array modulator is sufficient to generate the vector, in reality most SLMs are two-dimensional and work with slow modulation speed.

It is an object of the invention to provide methods and apparatus that allow optical multiplication to be performed more easily and/or quickly.

According to an aspect of the invention, there is provided an optical multiplication system, comprising: a deflector; a first modulator comprising rows and columns of first modulator elements and configured to spatially modulate light received from the deflector, wherein the first modulator is configured to encode values of a first matrix in the rows and columns of the first modulator elements, the first matrix defining a plurality of input vectors each corresponding to a respective row of the first matrix, and the deflector is configured to direct light from a source to illuminate a selected row or selected rows of the first modulator; a second modulator comprising rows and columns of second modulator elements and configured to spatially modulate light received from the first modulator, wherein the second modulator is configured to encode values of a second matrix in the rows and columns of the second modulator elements; and a light-summing optical arrangement configured to converge light output from each row of second modulator elements to encode a plurality of output vectors representing the results of vector-matrix multiplication between a respective plurality of the input vectors and the second matrix.

In prior art arrangements of the type discussed above with reference to FIG. 1, the two-dimensional modulation capacity of SLMs is not fully employed. Embodiments of the present disclosure allow fuller use of a modulator (e.g., the first modulator, which may be an SLM) through use of the deflector and by configuring the first modulator to simultaneously define multiple input vectors in different rows. A corresponding plurality of output vectors can be generated without the first modulator needing to be refreshed to change the encoded values of the first matrix. A relatively slow modulation speed of the first modulator will thus have less of a negative impact than in an arrangement of the type shown in FIG. 1 where the SLM 11 has to be switched between each vector-matrix multiplication and/or complex optics is necessary to distinguish between different vector-matrix multiplication results.

Embodiments of the present disclosure thus facilitate implementation of faster optical multiplication, which is advantageous in a range of applications, for example in solving modern computational problems where large-scale data processing and high computational speed is needed, such as optical neural networks and optical Ising machines. Embodiments can be used in singular-value decomposition.

In some embodiments, the deflector comprises an acoustic optical deflector. As will be described below in further detail, in the case of using an acoustic-optical deflector the inventors have demonstrated implementation of an OVMM system with two orders of magnitude higher throughput.

In some embodiments, the deflector is configured to illuminate individual rows of the first matrix in sequence, with different rows being illuminated at different respective times. This approach allows a sequence of OVMM operations to be performed at high speed with minimal detection complexity.

In some embodiments, the deflector is configured to simultaneously illuminate a plurality of the rows of the first matrix, the rows respectively encoding a corresponding plurality of the input vectors, and to simultaneously encode a plurality of the output vectors corresponding to the plurality of input vectors. This approach provides further improvements in speed relative to sequential generation of output vectors. A detector arrangement may individually read out each simultaneously encoded output vector using various approaches, such as based on differing frequencies or wave vectors.

According to an alternative aspect, there is provided an optical multiplication system, comprising: a light input arrangement; a first modulator comprising rows and columns of first modulator elements and configured to spatially modulate light received from the light input arrangement, wherein the first modulator is configured to encode values of a first matrix in the rows and columns of the first modulator elements, the first matrix defining a plurality of input vectors each corresponding to a respective row of the first matrix; a second modulator comprising rows and columns of second modulator elements and configured to spatially modulate light received from the first modulator, wherein the second modulator is configured to encode values of a second matrix in the rows and columns of the second modulator elements; a light-summing optical arrangement configured to converge light output from each row of second modulator elements to encode a plurality of output vectors representing the results of vector-matrix multiplication between a respective plurality of the input vectors and the second matrix; a third modulator comprising rows and columns of third modulator elements and configured to spatially modulate light received from the second modulator, wherein the third modulator is configured to encode values of a third matrix in the rows and columns of the third modulator elements; and a further light summing optical arrangement configured to converge light output from each column of third modulator elements to encode a plurality of further output vectors representing the results of vector-matrix multiplication between respective output vectors from the second modulator and the third matrix encoded by the third modulator.

Thus, a cascaded arrangement of more than two of the modulators may be provided. This allows more complex calculations to be performed, including matrix-matrix multiplication. For example, the system may be configured such that the combination of further output vectors represents the result of multiplication between the first matrix, second matrix, and third matrix. In some embodiments, one of the first modulator, second modulator and third modulator is set to encode a unity matrix such that the combination of the further output vectors represents a matrix-matrix multiplication between the two of the first modulator, second modulator and third modulator that have not been set to encode the unity matrix. Thus, high speed optical multiplication between two matrices may be achieved.

A two-stage cascaded system may implement an optical linear classifier, and an optical neural network can be readily built by inserting nonlinear optical elements between the two stages.

According to an alternative aspect, there is provided a method of performing optical multiplication, comprising: using a deflector to direct light from a source to illuminate a selected row or selected rows of first modulator elements of a first modulator; using the first modulator to spatially modulate light received from the deflector, wherein the first modulator encodes values of a first matrix in the rows and columns of the first modulator elements, the first matrix defining a plurality of input vectors each corresponding to a respective row of the first matrix; using a second modulator comprising rows and columns of second modulator elements to spatially modulate light received from the first modulator, wherein the second modulator encodes values of a second matrix in the rows and columns of the second modulator elements; and converging light output from each row of second modulator elements to encode a plurality of output vectors representing the results of vector-matrix multiplication between a respective plurality of the input vectors and the second matrix.

According to an alternative aspect, there is provided a method of performing optical multiplication, comprising: using a first modulator comprising rows and columns of first modulator elements to spatially modulate light received from a light input arrangement, wherein the first modulator encodes values of a first matrix in the rows and columns of the first modulator elements, the first matrix defining a plurality of input vectors each corresponding to a respective row of the first matrix; using a second modulator comprising rows and columns of second modulator elements to spatially modulate light received from the first modulator, wherein the second modulator is configured to encode values of a second matrix in the rows and columns of the second modulator elements; converging light output from each row of second modulator elements to encode a plurality of output vectors representing the results of vector-matrix multiplication between a respective plurality of the input vectors and the second matrix; using a third modulator comprising rows and columns of third modulator elements to spatially modulate light received from the second modulator, wherein the third modulator encodes values of a third matrix in the rows and columns of the third modulator elements;

and converging light output from each column of third modulator elements to encode a plurality of further output vectors representing the results of vector-matrix multiplication between respective output vectors from the second modulator and the third matrix encoded by the third modulator.

Embodiments of the disclosure will be further described by way of example only with reference to the accompanying drawings.

FIG. 1 is a conceptual schematic of OVMM.

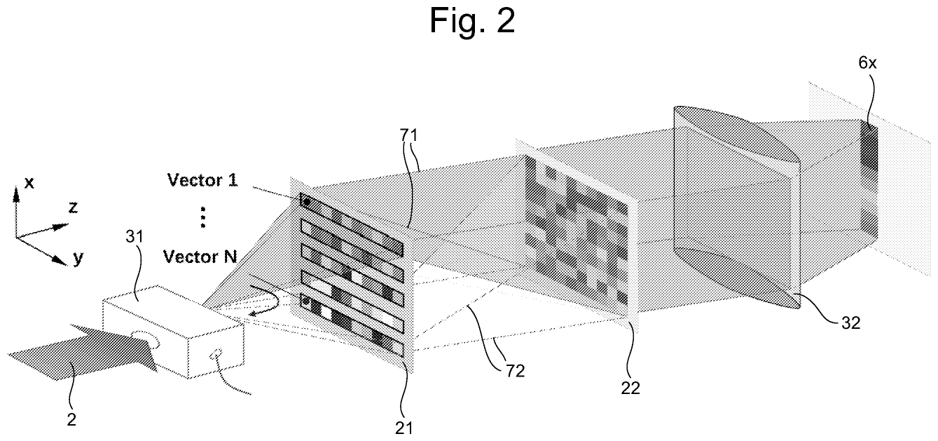

FIG. 2 schematically depicts an optical multiplication system using a deflector to achieve increased speed.

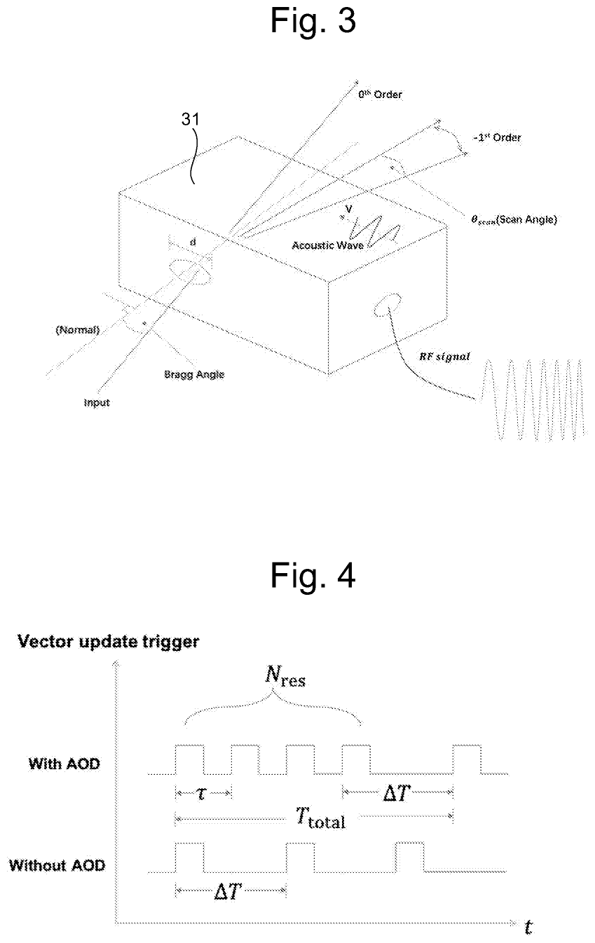

FIG. 3 schematically depicts the principle of acoustic optical deflection.

FIG. 4 is a timing diagram of the OVMM system with and without an acoustic optical deflector (AOD).

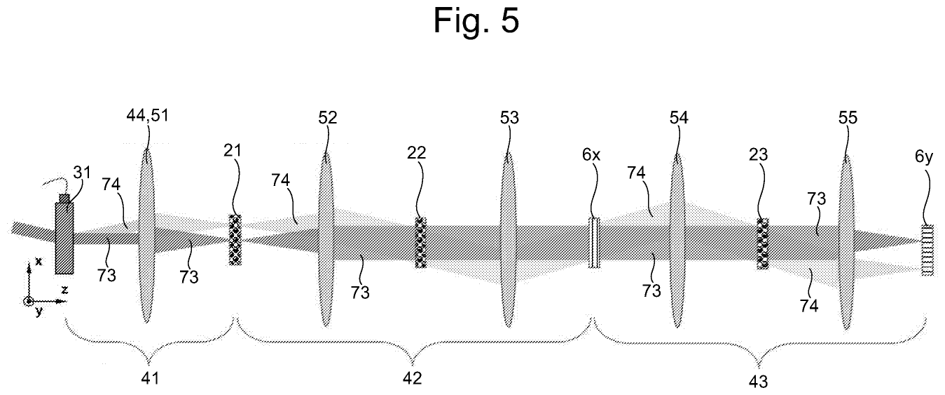

FIG. 5 schematically depicts implementation of a cascaded VMM with AOD.

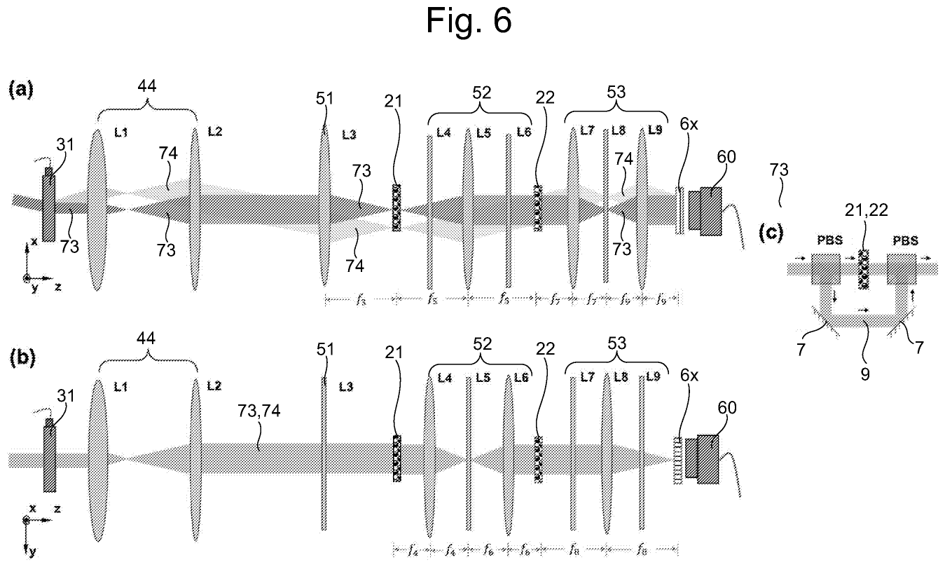

FIG. 6 schematically depicts implementation of OVMM with AOD, using cylindrical lenses for beam shaping. FIGS. 6(a) and 6(b) illustrate the optical path with two orthogonal cross-sections. FIG. 6(c) shows an optical bypass arrangement for providing an optical path around a modulator to provide a reference beam in a coherent system.

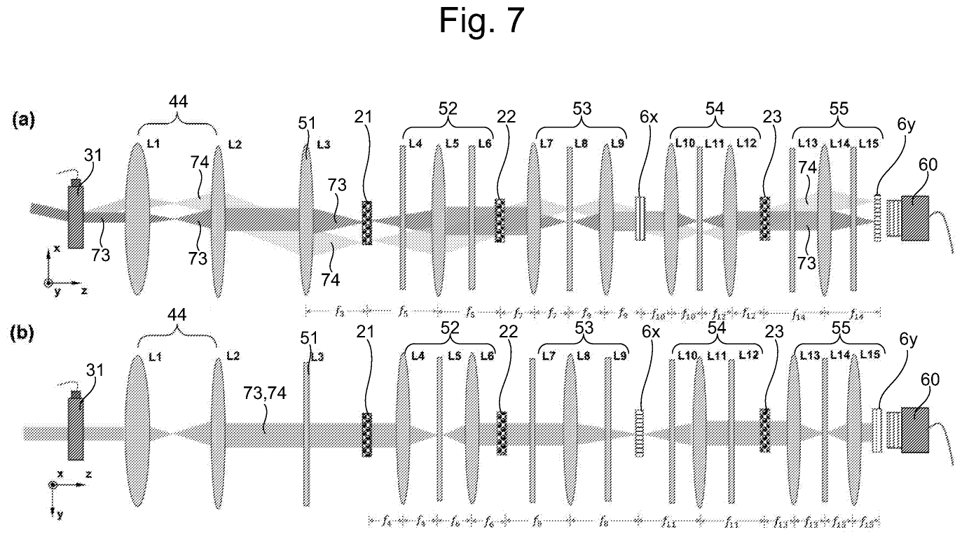

FIG. 7 schematically depicts a two-stage cascaded VMM system with AOD. FIGS. 7(a) and 7(b) illustrate the optical path for two orthogonal cross-sections.

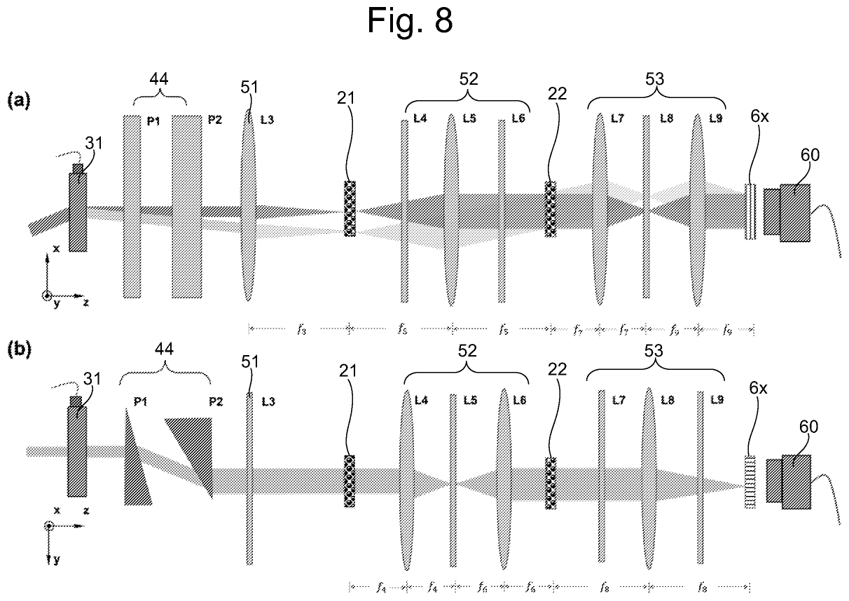

FIG. 8 schematically depicts an implementation of OVMM with AOD using prism pairs and a focus lens for beam shaping. FIGS. 8(a) and 8(b) illustrate the optical path for two orthogonal cross-sections. A prism pair is used to expand the beam waist in one transverse direction. The difference between the two acute angles in two right-triangle-shaped prisms determines the magnification factor of the beam waist.

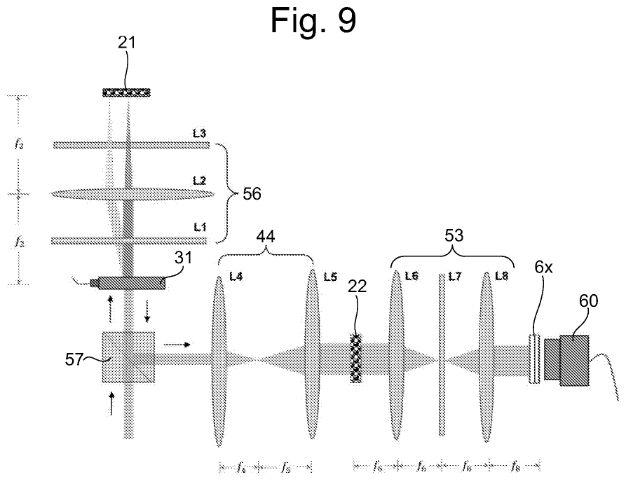

FIG. 9 schematically depicts an implementation of OVMM with a double-pass AOD arrangement to eliminate different linear phases of different vectors. A top view is shown with cylindrical lenses drawn to be elliptical or flat.

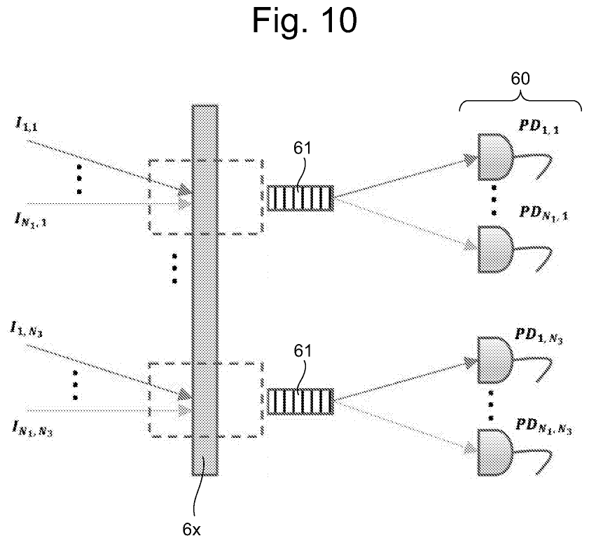

FIG. 10 schematically depicts detection of a matrix-matrix multiplication output.

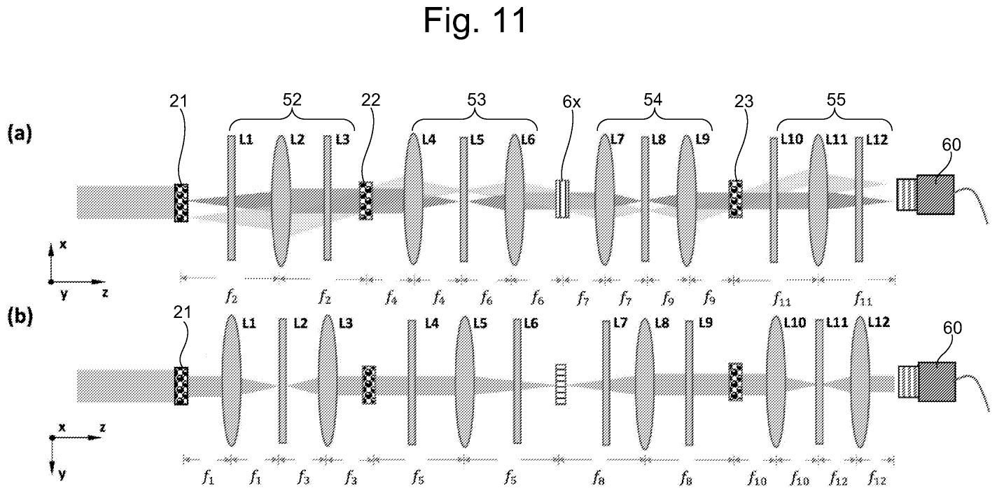

FIG. 11 schematically depicts an example implementation of a two-stage optical matrix-matrix multiplication (OMMM) system. FIGS. 11(a) and 11(b) are viewed from two different transverse direction respectively.

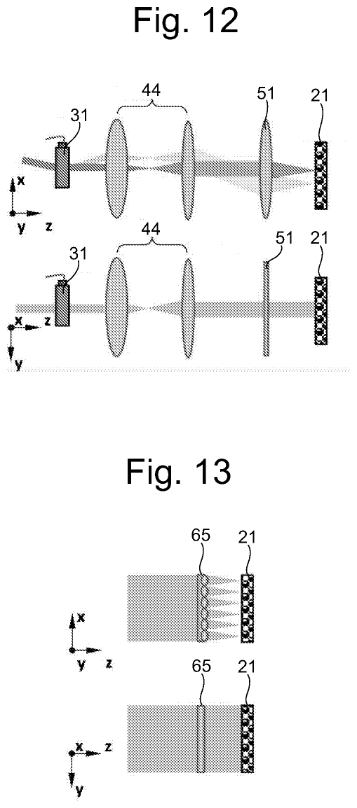

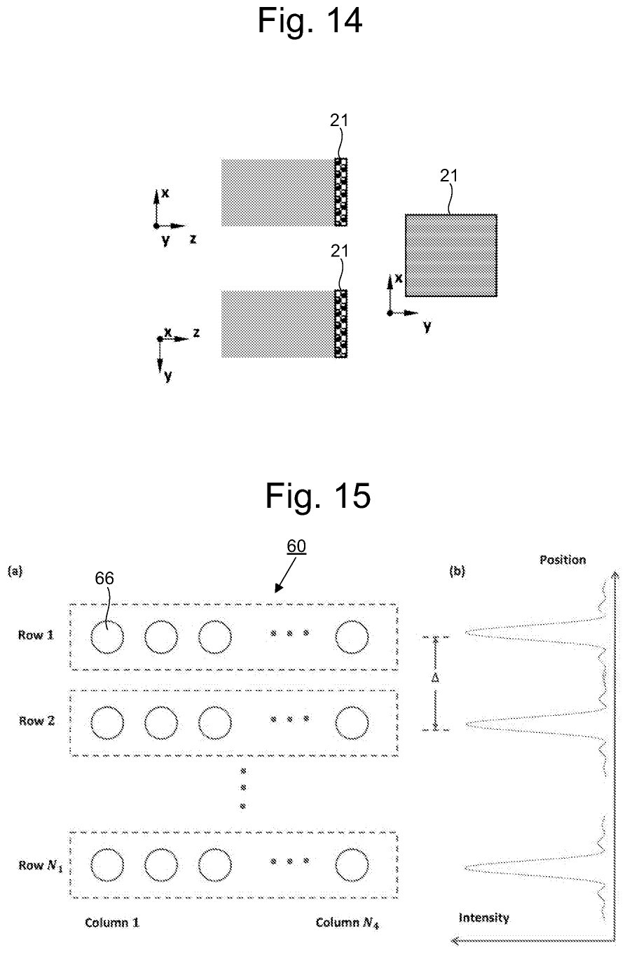

FIGS. 12-14 schematically depict three example implementations of a light input arrangement for the system of FIG. 11. In the approach of FIG. 12, an AOD is used to illuminate multiple rows of a first modulator. In the approach of FIG. 13, a cylindrical lenslet array is used to focus the beam onto multiple rows of the first modulator. In the approach of FIG. 14, the first modulator is illuminated by a broad uniform beam, and only several narrow rows on the first modulator are turned on.

FIG. 15 schematically depicts implementation of a detector arrangement in the two-stage OMMM system of FIGS. 11-14. FIG. 15(a) depicts the output plane for detection of the multiplication between three matrices. A is the distance between neighbouring detector rows. A detector arrangement can be either a photodetector or a few pixels on a camera. FIG. 15(b) depicts intensity distribution across different rows.

Embodiments of the disclosure provide an optical multiplication system.

Referring initially to the example of FIG. 2, in one class of embodiment the optical multiplication system comprises a deflector 31, a first modulator 21, a second modulator 22, and a light summing optical arrangement 32.

The first modulator 21 comprises rows and columns of first modulator elements. The first modulator 21 spatially modulates light received from the deflector 31 using the first modulator elements. The first modulator 21 encodes values of a first matrix in the rows and columns of the first modulator elements (e.g. in respective transmission functions of the first modulator elements). The first modulator elements may be pixels of a spatial light modulator, for example. Each pixel may be individually controllable/programmable to define a transmission function of the pixel. The transmission function may define a modulation to be applied by the pixel to the phase and/or amplitude of the electric field of light interacting with the pixel. The first matrix defines a plurality of input vectors. Each input vector corresponds to a respective row of the first matrix (and therefore to a respective row of the first modulator elements). In the example of FIG. 2 each row extends parallel to the y-axis. Example input vectors 1 to N are indicated in FIG. 2. The deflector 31 directs light 2 from a source (not shown) to illuminate a selected row or selected rows of the first modulators. Thus, the deflector 31 can simultaneously illuminate a single input vector or multiple input vectors. The system may be configured to periodically switch the first modulator 21 to encode different pluralities of input vectors in the rows of the first matrix. This may be done, for example, after detection of the results of all desired multiplication operations involving the input vectors encoded by the first modulator at a given point in time.

The second modulator 22 comprises rows and columns of second modulator elements. The second modulator elements may take any of the forms described above for the first modulator elements. The second modulator 22 spatially modulates light received from the first modulator 21 using the second modulator elements. The second modulator 22 encodes values of a second matrix in the rows and columns of the second modulator elements.

The light summing arrangement 32 converges light output from each row of second modulator elements (in the second modulator 22) to encode a plurality of output vectors. Thus, in the example shown, light from the top row of second modulator elements is converged to define the value of a first element of the output vector, light from the next row of second modulator elements (one down) is converged to define the value of a second element of the output vector (one down from the first element), etc. The output vectors represent the results of vector-matrix multiplication between a respective plurality of the input vectors and the second matrix. In some embodiments, as exemplified in FIG. 2, the light summing arrangement 32 comprises a cylindrical lens. In some embodiments, as exemplified in FIG. 2, light from the light summing arrangement 32 is directed onto a slit 6x. In the example of FIG. 2 the slit 6x extends parallel to the x-direction (perpendicular to the rows of the first modulator 21 that define the input vectors). The slit 6x may be configured to select a zeroth order component of light from the second modulator 22.

In the embodiment of FIG. 2, the deflector 31 illuminates individual (i.e. single) rows of the first matrix in sequence. Different rows are thus illuminated at different respective times. The rows correspond to individual input vectors, so the deflector causes the input vectors to be multiplied by the system one at a time in sequence. The output vectors encode the results of the vector-matrix multiplication of the input vectors and the second matrix in a sequence corresponding to the sequence of illumination of the rows of the first matrix. Thus, in this example the plurality of output vectors are encoded one at a time, each corresponding to a respective different one of the input vectors.

In some embodiments, the deflector 31 comprises an acoustic optical deflector (AOD). The AOD deflects light from its original path with the angle of deflection controlled by a driving radio-frequency (RF) signal. In the example of FIG. 2, with the help of a cylindrical lens set (not shown in FIG. 2), the exiting beam from the deflector 31 illuminates only one row on the first modulator 21 at a time. The sequential illumination of rows of the first modulator 21 described above, in which individual input vectors are addressed individually, can be achieved by sweeping the RF frequency to deflect the beam at different angles corresponding to the positions of the respective rows of first modulator elements.

In some embodiments, a light-expanding optical arrangement (not shown in FIG. 2) is provided between the first modulator 21 and the second modulator 22. As exemplified in FIGS. 5-9 and 11 described below, the light-expanding optical arrangement may comprise a cylindrical lens set 52. The light-expanding optical arrangement spreads light from each first modulator element of an illuminated row of the first modulator elements onto a column of the second modulator elements. Thus, light from a single illuminated row on the first modulator 21 may be made to illuminate a two-dimensional array of second modulator elements of the second modulator 22. The light exiting the second modulator 22 is summed by the light summing optical arrangement 32 (e.g. a cylindrical lens).

When being expanded and projected onto the second modulator 22, the light beams coming from different rows of the first modulator 21 (e.g. indicated schematically by ray boundaries 71 and 72 respectively in FIG. 2) experience different non-zero incidence angles. In coherent settings, this results in different linear phases at the plane of the slit 6x. However, this phase term can be eliminated via interferometric measurement and will not affect the VMM result. In incoherent settings, the phases will not matter for intensity measurement. In this case, the scanning speed of AOD and maximum number of resolvable vectors in the plane of the first modulator 21 (which may be referred to as a vector plane), rather than the modulation speed of the first modulator 21 (which may be relatively slow, for example in the case of a typical SLM), may predominantly determine the computational speed of the OVMM system. By selecting state-of-art AOD devices with hundreds of resolvable spots, the computational speed of an OVMM system can be accelerated by up to two orders of magnitude relative to alternative approaches such as that depicted in FIG. 1.

FIG. 3 shows the working principle of a deflector 31 implemented by an AOD. The AOD is operated using periodic modulation of the optical index of refraction caused by an acoustic wave propagating in a transparent material. An optical wave passing through the region containing the acoustic wave will experience a periodic phase modulation that can produce a corrugation of the optical wavefront, which will in turn diffract the optical wave into multiple orders. The incident angle is set close to the Bragg angle, while the output diffraction order will scan over a region according to the sweeping RF signal which is driving the device.

The range of deflection angle for the first diffraction order, θ_{scan}, is given by the velocity of the acoustic wave in the AOD device, V, the bandwidth of the RF signal driving the device, Δf, and the wavelength of the light, λ:

$${θ}_{s c a n} = \frac{λΔ f}{V} .$$

When the RF signal is sweeping, a short time delay is needed for the output beam at each diffraction angle to obtain stable response. This is characterised by the access time of the device, τ, defined as the time for the acoustic wave to travel across the optical aperture of width d:

$$τ = \frac{d}{V} .$$

Due to the diffraction of the beam, the number of resolvable spots, Nᵣₑₛ, within the range of scanning θ_{scan}, is limited by the size of each spot at different angles:

$${N}_{r e s} = \frac{{θ}_{s c a n}}{Δ θ} ,$$

where Δθ is given by the Rayleigh principle, Δθ=λ/d. Therefore, in terms of RF bandwidth and access time:

$${N}_{r e s} = τ \cdot Δ f .$$

FIG. 4 shows how vectors may be updated in a system with and without a deflector 31 implemented by an AOD.

For an OVMM system without AOD, such as that shown in FIG. 1, the update speed of the vector may be determined by the refresh period ΔT of a first SLM 11. During each period, a single VMM computation is undertaken and therefore the number of vectors being processed per unit time is

$${N}_{1} = \frac{1}{Δ T} .$$

For such an OVMM system without AOD, the update speed of the vector is determined by the refresh period ΔT of the first SLM 11. During each period, a single VMM computation is undertaken and therefore the number of vectors being processed per unit time is

$${T}_{total} = τ {N}_{r e s} + Δ T .$$

In an implementation using an AOD, as exemplified in FIG. 2, assuming the resolution of the first modulator 31 (vector SLM) is high enough to accommodate all the resolvable spots from the AOD, which is usually the case in practice, the first modulator 31 does not add further limitations to the number of resolvable vectors. Then because Nres multiplication operations are taken within a single period, the number of vectors being processed per unit time is now

$${N}_{2} = \frac{{N}_{r e s}}{{T}_{total}} = \frac{1}{τ + Δ T / {N}_{r e s}} .$$

The speed-up factor F achieved through the described use of the AOD is thus

$$F = \frac{{N}_{2}}{{N}_{1}} = \frac{Δ T}{τ + Δ T / {N}_{r e s}} < {N}_{r e s} .$$

Taking typical values of ΔT=100 μs, τ=0.5 μs, Nᵣₑₛ=200, we have F=100. If the SLM is even slower, we can obtain two-order-of-magnitude speed up approaching Nᵣₑₛ=200. The overall computation speed for an OVMM system with AOD, taking an example size of the matrix as 2000×1000, is

$${N}_{3} = {N}_{2} \times 2000 \times 1000 = 2 TOPS .$$

The modulator elements of either or both of the first modulator 31 and the second modulator 32 will typically be programmable. Either or both of the first modulator 31 and the second modulator 32 may for example comprise a digital micromirror device (DMD) or a liquid crystal spatial light modulator (LC-SLM).

DMD: DMDs are binary, amplitude-only modulators which have only two states for each pixel, ‘on’ and ‘off’. Each pixel is a micro-mirror, and modulation speed can reach 10 kHz, and the pixels can be updated in a pipeline, making them suitable in tasks requiring fast data processing. By encoding proper binary grating patterns on the DMD, one can also generate patterns with arbitrary amplitudes and phases. Both LC-SLMs and DMDs can be used to compensate for phase distortions and aberrations in the optical system.

LC-SLM: LC-SLMs are usually 8-bit or 10-bit phase-only modulators with slow modulation speed, typically 50-60 Hz. By displaying different phase grating patterns, LC-SLMs can be used to generate arbitrary complex fields at a given diffraction order. However, while LC-SLMs are capable of high-quality spatial modulation, their slow modulation speed makes them unsuitable in computational tasks where data must be rapidly updated.

In some embodiments, a cascaded system is provided by adding a third modulator 23 downbeam of the first and second modulators 21, 22. An example configuration is shown in FIG. 5. In such embodiments, the third modulator 23 comprises rows and columns of third modulator elements. The third modulator elements may take any of the forms described above for the first and/or second modulator elements. The third modulator 23 spatially modulates light received from the second modulator 23 using the third modulator elements. The third modulator 23 encodes values of a third matrix in the rows and columns of the third modulator elements. A further light summing arrangement may be provided downbeam of the third modulator 23. The further light summing optical arrangement converges light output from each column of third modulator elements to encode a plurality of further output vectors representing the results of vector-matrix multiplication between respective output vectors from the second modulator 22 and the third matrix encoded by the third modulator 23.

A deflector (e.g. AOD)-assisted OVMM system can be cascaded to perform multiple VMMs in series. The example of FIG. 5 shows a two-stage OVMM system. The example system comprises three parts: a beam-shaping optical arrangement 41 between a deflector 31 and a first modulator 21; a first vector-matrix multiplication (VMM) stage 42 comprising a first modulator 21 and a second modulator 22; and a second vector-matrix multiplication (VMM) stage 43 comprising a third modulator 23.

Beam-shaping arrangement 41: The beam-shaping optical arrangement 41 may shape a beam from the deflector 31 to illuminate individual rows of first modulator elements of the first modulator 21. The light exiting the deflector (AOD) (two example beams are indicated by labels 73 and 74 in FIG. 5) may have a small beam waist, for example around 1 mm. In the example shown, lens set 44, 51 in the beam-shaping optical arrangement 41 expands the beam along the y-direction to match the beam profile with a single row of first modulator elements on the first modulator 21 (e.g., vector SLM). In some embodiments, the beam-shaping optical arrangement 41 may comprise a cylindrical lens 51 (see FIG. 7) to converge the beam in a direction perpendicular to the row of first modulator elements to be illuminated. In some embodiments, the beam-shaping optical arrangement 41 comprises a beam expander 44 (see FIG. 7) to expand the beam in a direction parallel to the row of first modulator elements to be illuminated.

First VMM stage 42: In the first VMM stage 42, in the example shown a beam is expanded by a cylindrical lens set 52 along the x-direction to match the size of the second modulator elements defining the second matrix in the second modulator 22. After passing through the second modulator 22, a cylindrical lens set 53 sums the products along the y-direction and forms the first VMM output at the slit 6x, aligned along the x-direction. In a coherent setting, the beam appearing from the deflector 31 (e.g., AOD) at different times illuminates different vector rows in the first modulator 21, and will have different additional linear phases at the plane of the slit 6x. This will not affect the interferometric measurement outcome.

Second VMM stage 43: The beam propagates into the second VMM stage 43 as a vector along the x-direction. Cylindrical lens sets 54 and 55 take similar roles to cylindrical lens sets 52 and 53 except that they are oriented with 90° rotations around the z-axis. A slit 6y over the y-direction is used to collect the final result. This slit 6y is at the image plane (or near-field) of the input vector plane (the plane of the first modulator 21) and hence shows different displacements along the x-direction at different times, corresponding to the different input vector positions.

Such an OVMM system can be cascaded for two layers. This scheme can then be naturally extended to multiple stages by repeatedly adding optical elements corresponding to the first and second VMM stages alternately. The vector outputs after an odd number of stages are at the far-field of the vector plane (the plane of the first modulator 21), and are collected by a slit 6x perpendicular to the input. They have a linear phase along the slit direction, which will not affect measurements as discussed above. Meanwhile, outputs after an even number of stages are at the near-field of the vector plane and are collected by a slit 6y parallel to the input vector. They will have different spatial displacements, but can be properly measured by using a camera or arrays of photo-detectors.

FIG. 6 depicts an example implementation of OVMM with AOD speed-up in further detail. FIGS. 6(a) and 6(b) illustrate the optical path with two orthogonal cross-sections. Input vectors forming a first matrix are encoded in a first modulator 21 and a second matrix is encoded in a second modulator 22. For illustration purpose, two beams 73 and 74 are shown which are generated at two different RF frequencies applied to the deflector 31. The two beams 73 and 74 perform two different VMMs. In this embodiment, the two beams 73 and 74 do not coexist at the same time but are generated instead in sequence one after the other. A detector arrangement 60 is provided that detects the output vectors. The detector arrangement 60 may be a camera or photodetector array for example. If a camera is used, the slit 6x before the camera will be unnecessary and can be removed. For illustration purposes, the first and second modulators 21 and 22 are shown as transmissive devices, but this is not essential. Indeed, in practice the two modulators will often be implemented as reflective devices. In the case where the light source comprises a coherent source, the detector arrangement 60 may detect electric field amplitudes of light representing the output vectors using interference with a reference beam. FIG. 6(c) shows an optical path around a modulator for providing a reference beam in such a coherent system. FIG. 6(c) is an example of an optical bypass arrangement that allows the reference beam to bypass each of the modulators without being modulated. In the case where the light source comprises an incoherent source, the detector arrangement 60 may detect intensities of light representing the output vectors.

In the embodiment of FIG. 6, a beam-shaping arrangement between an AOD acting as deflector 31 and the first modulator 21 comprises a beam expander 44. The beam expander 44 comprises a telescope comprising two spherical lenses L1 and L2. The beam expander 44 expands an output beam from the deflector 31 so that the output beam covers an active area of the first modulator 21. The beam-shaping arrangement further comprises a cylindrical lens 51, L3 that converges the beam in the x-direction so that it illuminates a single row on the first modulator 21. During the sweeping of the driving RF frequency applied to the AOD, the beam scans different rows sequentially (e.g. from the beam labelled 73 to the beam labelled 74, for example). A cylindrical lens L5 then performs Fourier transform in the x-direction, and two cylindrical lenses L4 and L6 perform 4F imaging in the y-direction, so that the illuminated vector (defined within the first matrix) on the plane of the first modulator 21 is multiplied with the second matrix defined on the plane of the second modulator 22. The cylindrical lenses L4-L6 may be referred to as a cylindrical lens set 52. After the multiplication, a cylindrical lens L8 performs Fourier transform (or summing of the result) in the y-direction. The result is passed through a narrow slit 6x to obtain the VMM result. The slit 6x may be configured to select a zeroth order spatial frequency of the light to provide the output. In the x-direction another pair of cylindrical lenses L7 and L9 perform 4F imaging for suppression of diffraction. The cylindrical lenses L7-L9 may be referred to as a cylindrical lens set 53. In a coherent system, interference can be used to measure the result. FIG. 6(c) shows the optical path around the modulators 21, 22 in this setting. Inserting a polarizing beam splitter (PBS) before each modulator splits the beam into two arms according to the polarization of input beam, and after the modulator 21, 22 a second PBS is used to recombine the two arms. Light in the second arm remains unmodulated and forms the reference beam, as mentioned above. The reference beam hits the detector arrangement 60 with the same vector-dependent linear phase as the signal beam. Therefore, it can be used to interfere with the VMM signal at the output, and the VMM result can be read out.

FIG. 7 depicts an example implementation of a two-stage cascaded OVMM system. FIGS. 7(a) and 7(b) illustrate the optical path for two orthogonal cross-sections. The second stage involves two further cylindrical lens sets 54 and 55 (relative to the arrangement of FIG. 6). The further cylindrical lens sets 54 and 55 comprise cylindrical lenses L10-L15 in a corresponding configuration to the cylindrical lenses L4-L9 of the cylindrical lens sets 52 and 53 but are oriented with 90° rotations around the z-axis.

FIG. 8 depicts a variation on the embodiment of FIG. 6 in which the beam expander 44 comprises a prism pair instead of the telescope of FIG. 6. FIGS. 8(a) and 8(b) illustrate the optical path for two orthogonal cross-sections. The prism pair is used to expand the beam waist in one transverse direction. The difference between the two acute angles in two right-triangle-shaped prisms determines the magnification factor of the beam waist.

FIG. 9 depicts a variation on the embodiment of FIG. 6 in which a deflector 31 (e.g. AOD) double-pass arrangement is adopted to eliminate the vector-related linear phase and position shift at the VMM output plane. After the input vectors defined in the first matrix at the plane of the first modulator 21 are illuminated, the beam is retroreflected back into the deflector (e.g., AOD), so that the deflection is cancelled. A cylindrical lens set 56 is provided between the deflector 31 and the first modulator 21. FIG. 9 is a top view so the cylindrical lenses L1-L3 are drawn to be elliptical or flat. The double-pass beam is then directed by a beam splitter 57 to the following second modulator 22 and finishes the VMM. In this case, the double-pass beam experiences two times of the RF frequency shift, but this does not affect the VMM. It is noted that one can alternatively unfold the optical path from the deflector 31 to the first modulator 21, and use two separate single-pass deflectors 31 (e.g., AODs) to eliminate the vector-related linear phases and position shift similarly. The embodiment of FIG. 9 is thus an example of an arrangement in which an optical manipulation of light in a path from the deflector 31 to the first modulator 21 is reversed before the light is directed to the second modulator 22. In the example of FIG. 9, the reversal of the optical manipulation is implemented by reflecting light from the first modulator 21 back through the deflector 31 before directing the light to the second modulator 22. In the alternative unfolded option, the reversal of the optical manipulation is implemented by directing the light from the first modulator 21 through an optical arrangement containing optical elements and a further deflector corresponding respectively in reverse order to the deflector 31 and optical elements present between the deflector 31 and the first modulator 21.

In some embodiments, the deflector 31 is used to simultaneously illuminate a plurality of the rows of the first matrix, optionally being all of the rows of the first matrix, with the rows respectively encoding a corresponding plurality of the input vectors. The system can then simultaneously encode a plurality of the output vectors corresponding to the plurality of input vectors. In the case of a deflector 31 implemented using an AOD, this functionality may be achieved by sending a superposition of multiple RF signals to the AOD, which causes illumination of multiple rows on the first modulator 21 and provides multiple corresponding optical outputs at the same time. This is in contrast to the sequential approach described above with reference to FIG. 2 for example, where a single-frequency RF signal may be sent to the AOD at any one time, which generates a corresponding single optical output at one time. This approach can be applied particularly effectively to implementing optical matrix-matrix multiplication (MMM).

In such embodiments, a detector arrangement 60 is provided that is capable of individually reading out the multiple simultaneously encoded output vectors. In the present example, the output beams from the AOD propagate through the system and simultaneously produce different VMM outputs at the same position on the plane of slit 6x (output plane). Though they overlap at the spatial position at the output plane, they will have different x-component of wave vectors and different wavelengths as well. The detector arrangement 60 may be configured to distinguish between different encoded output vectors on the basis of frequency or wave vector. The detector arrangement 60 may comprise a specially designed camera or photodetector array after the slit 6x (e.g. directly after) that will be able to detect these signals simultaneously, for example by distinguishing components of different frequencies or wave vectors.

FIG. 10 depicts an example configuration for distinguishing between simultaneously encoded output vectors corresponding to different respective input vectors. In this example, spatial gratings or spatial mode sorters 61 are provided between the slit 6x and a detector arrangement 60 (e.g. camera/photodetector array). I_{i,j} refers to the element of an output matrix that is the multiplication of i-th row on a first input matrix (e.g. a first matrix defined by a first modulator 21 in the example described below) and j-th row on a second input matrix (e.g. a second matrix defined by a second modulator 22 in the example described below), where i=1, 2, . . . . N₁, j=1, 2, . . . , N₃. The dimensions of these two matrices are N₁×N₂ and N₃×N₂. Elements I_{i,j} of the same index j hit the same detection region at different incidence angles on the plane of slit 6x. After a wavelength or a wave vector sorter, output at each of N₃ detection regions is sent to N₁ different photodetectors or different areas on a camera. PD_{i,j} refers to the detector unit of the detector arrangement 60 for measuring I_{i,j}.

An example implementation is now described with reference to FIG. 11. The implementation is based on the cascaded optical VMM system with two VMM stages described above with reference to FIGS. 5 and 7, with corresponding elements being given corresponding reference numerals. As discussed above, output vectors after the second VMM stage will have different spatial displacements. Therefore, if multiple-tone RF signals are sent to the AOD, we will have a two-dimensional array at the output plane (the plane of the detector arrangement 60). This output is the matrix-multiplication of three matrices corresponding to the three modulators (the first modulator 21, second modulator 22, and third modulator 23). In this case, one can also implement the MMM by displaying an identity matrix on one of these three modulators or simply replacing it with a narrow diagonal slit.

Thus, as exemplified in FIG. 11, in the embodiment, an optical multiplication system may be provided that comprises a light input arrangement, a first modulator 21, a second modulator 22, a light-summing arrangement, a third modulator 23, and a further light summing arrangement.

The first modulator 21 comprises rows and columns of first modulator elements. The first modulator 21 spatially modulates light received from the light input arrangement. The first modulator 21 encodes values of a first matrix in the rows and columns of the first modulator elements. The first matrix defines a plurality of input vectors each corresponding to a respective row of the first matrix (although the first matrix may simply be considered as a matrix when the aim is to perform matrix-matrix multiplication rather than vector-matrix multiplications). The first modulator 21 may take any of the forms described above with reference to FIGS. 2-9.

The second modulator 22 comprises rows and columns of second modulator elements. The second modulator 22 spatially modulates light received from the first modulator 21. The second modulator 22 encodes values of a second matrix in the rows and columns of the second modulator elements. The second modulator 22 may take any of the forms described above with reference to FIGS. 2-9.

The light-summing optical arrangement (implemented by cylindrical lens set 53) converges light output from each row of second modulator elements to encode a plurality of output vectors representing the results of vector-matrix multiplication between a respective plurality of input vectors defined by the first matrix and the second matrix. The light-summing optical arrangement may take any of the forms described above with reference to FIGS. 2-9.

The third modulator 23 comprises rows and columns of third modulator elements. The third modulator 23 spatially modulates light received from the second modulator 22. The third modulator 23 encodes values of a third matrix in the rows and columns of the third modulator elements. The second modulator 23 may take any of the forms described above with reference to FIGS. 2-9.

The further light summing optical arrangement (implemented by lens set 85) converges light output from each column of third modulator elements to encode a plurality of further output vectors representing the results of vector-matrix multiplication between respective output vectors from the second modulator 22 and the third matrix encoded by the third modulator 23. The further light summing optical arrangement may take any of the forms described above with reference to FIGS. 2-9.

The combination of the further output vectors may represent the result of multiplication between the first matrix, second matrix, and third matrix. In some embodiments, the system is configured such that one of the first modulator 21, second modulator 22 and third modulator 23 is set to encode a unity matrix such that the combination of the further output vectors represents a matrix-matrix multiplication between the two of the first modulator 21, second modulator 22 and third modulator 23 that have not been set to encode the unity matrix. For example, when the first modulator 21 encodes the unity matrix, the further output vectors represent multiplication of the second matrix by the third matrix. When the second modulator 22 encodes the unity matrix, the further output vectors represent multiplication of the first matrix by the third matrix. When the third modulator 23 encodes the unity matrix, the further output vectors represent multiplication of the first matrix by the second matrix.

In some embodiments, the light input arrangement comprises a deflector 31. The deflector 31 may be implemented using any of the configurations described above. The deflector 31 may comprise an AOD for example. One example configuration is depicted in FIG. 12. This configuration may be implemented in the same way as described above for the corresponding elements in the embodiment of FIG. 6.

In other embodiments, the light input arrangement may use an arrangement other than a deflector/AOD. In one example, a cylindrical lenslet array 65 may be used as exemplified in FIG. 13. The cylindrical lenslet array 65 may be configured to focus an incoming beam from a source onto multiple respective rows of the first modulator 21 (e.g. with one row corresponding to each lenslet in the array). In another example, a full region of the first modulator 21 is illuminated and only selected narrow rows of first modulator elements are turned on, as exemplified in FIG. 14.

In order to detect these array-shaped outputs, a detector arrangement 60 may be implemented using a camera with high resolution or a two-dimensional array of photodetectors, as exemplified in FIG. 15. In this situation, each row of detection units 66 of the detector arrangement 60 may desirably be separated from neighbouring rows to avoid undesired interference.

### Computational Speed—Single Stage Multiplier

In this case, MMM is implemented and a wavelength/wave vector sorter is used to detect the final output as discussed above. Let the dimension of the two matrices on the two modulators (first modulator 21 and second modulator 22) be N₁×N₂ and N₃×N₂. As shown in FIG. 10, on the output plane, the beams hit at N₃ detection regions, and N₁ beams with different wavelengths/wave vectors are sorted at each detection region. During a single update period of the modulators, N₁×N₂×N₃ element wise multiplication and summation are calculated and the total computational speed would be

$$P = 2 {N}_{1} {N}_{2} {N}_{3} {f}_{S L M}$$

where f_{SLM} is the updating frequency of matrix for the modulators. Taking typical values of f_{SLM}=10 kHz, N₁=N₂=N₃=1000, the computation speed can reach 10¹³ operations per second.

### Computational Speed—Two-Stage Multiplier

In this case, multiplication of three matrices is implemented and the final output are detected by a photodetector array/a camera with high resolution. Let the dimension of the three matrices on the three modulators (first modulator 21, second modulator 22, and third modulator 23) be N₁×N₂, N₃×N₂, N₃×N₄, and the output pattern will have a shape of N₁×N₄ as shown in FIG. 15. Because of diffraction, the height of each row at the output plane is

$$δ = \frac{f λ}{{L}_{3} / {N}_{3}}$$

where λ is the operation wavelength, f is the focal length of the lens, L₃ is the geometric aperture on the N₃ dimension, and L₃/N₃ is the geometric size of each matrix element on this dimension. We require δ to be smaller than the separation of neighbouring detecting regions Δ. Because the output plane is the image of the first matrix plane, the separation distance between adjacent rows is Δ=L₁/N₁, L₁ is the geometric aperture on the N₁ dimension. Therefore δ<Δ means

$${N}_{1} {N}_{3} < \frac{{L}_{1} {L}_{3}}{f λ}$$

The right hand side of the equation above is also known as the space-bandwidth product. The computation speed is

$$P = 4 {N}_{1} {N}_{2} {N}_{3} {N}_{4} {f}_{S L M} < 4 {N}_{2} {N}_{4} \frac{{L}_{1} {L}_{3}}{f λ} {f}_{S L M}$$

where f_{SLM} is the updating frequency of matrices for the modulators. Taking typical values of N₂=N₄=1000, f_{SLM}=10 kHz, L₁=L₃=1 cm, f=500 mm, λ=500 nm, we can reach

$$P = 1.6 \times 1 {0}^{13} operations per second .$$

### Computational Speed—Multiple Stage Multiplier

If multiple optical MMM stages are used, we are able to do multiple-matrix multiplication. The advantage of system described herein, compared to traditional digital systems, is that the time used to perform the computation almost does not scale with the number of stages (number of matrices engaged). This is because the computation time of the systems described herein is limited by the inter-conversion between optics and electronics during the data writing or reading process. Therefore, by increasing the number of stages N, the total computational capacity scales exponentially with N and does not have a limit. However, when N is large enough such that the propagating time of light is no longer negligible as compared to the opto-electronic inter-conversion time, then the computation time would be proportional to N.

1. An optical multiplication system, comprising:
a deflector;
a first modulator comprising rows and columns of first modulator elements and configured to spatially modulate light received from the deflector, wherein the first modulator is configured to encode values of a first matrix in the rows and columns of the first modulator elements, the first matrix defining a plurality of input vectors each corresponding to a respective row of the first matrix, and the deflector is configured to direct light from a source to illuminate a selected row or selected rows of the first modulator;
a second modulator comprising rows and columns of second modulator elements and configured to spatially modulate light received from the first modulator, wherein the second modulator is configured to encode values of a second matrix in the rows and columns of the second modulator elements; and
a light-summing optical arrangement configured to converge light output from each row of second modulator elements to encode a plurality of output vectors representing the results of vector-matrix multiplication between a respective plurality of the input vectors and the second matrix.

2. The system of claim 1, wherein the deflector comprises an acoustic optical deflector.

3. The system of claim 1, wherein the deflector is configured to illuminate individual rows of the first matrix in sequence, with different rows being illuminated at different respective times.

4. The system of claim 3, wherein the output vectors encode the results of the vector-matrix multiplication of the input vectors and the second matrix in a sequence corresponding to the sequence of illumination of the rows of the first matrix.

5. The system of claim 1, wherein the deflector is configured to simultaneously illuminate a plurality of the rows of the first matrix, the rows respectively encoding a corresponding plurality of the input vectors.

6. The system of claim 5, configured to simultaneously encode a plurality of the output vectors corresponding to the plurality of input vectors.

7. The system of claim 6, comprising a detector arrangement configured to individually read out each simultaneously encoded output vector.

8. The system of claim 7, wherein the detector arrangement is configured to distinguish between different simultaneously encoded output vectors on the basis of one or more of the following light properties: frequency; wave vector.

9. The system of claim 1 configured such that an optical manipulation of light in a path from the deflector to the first modulator is reversed before the light is directed to the second modulator.

10. The system of claim 9, wherein the reversal of the optical manipulation is implemented by reflecting light from the first modulator back through the deflector before directing the light to the second modulator.

11. The system of claim 9, wherein the reversal of the optical manipulation is implemented by directing the light from the first modulator through an optical arrangement containing optical elements and a further deflector corresponding respectively in reverse order to the deflector and optical elements present between the deflector and the first modulator.

12. The system of claim 1, comprising a light-expanding optical arrangement between the first modulator and the second modulator, the light-expanding optical arrangement being configured to spread light from each first modulator element of an illuminated row of the first modulator elements onto a respective column of the second modulator elements.

13. The system of claim 1, wherein the light-summing arrangement comprises a cylindrical lens.

14. The system of claim 1, further comprising a beam-shaping optical arrangement between the deflector and the first modulator, the beam-shaping optical arrangement being configured to shape a beam from the deflector to illuminate individual rows of the first modulator elements.

15. The system of claim 14, wherein the beam-shaping optical arrangement comprises a cylindrical lens to converge the beam in a direction perpendicular to the row of first modulator elements to be illuminated.

16. The system of claim 14, wherein the beam-shaping optical arrangement comprises a beam expander to expand the beam in a direction parallel to the row of first modulator elements to be illuminated.

17. The system of claim 16, wherein the beam expander comprises a telescope arrangement or a pair of prisms.

18. The system of claim 1, wherein the light-summing optical arrangement is configured to perform a Fourier transform and the system comprises a slit to select a zeroth order spatial frequency of the light to provide the output vectors.

19. The system of claim 1, wherein the first modulator elements and/or the second modulator elements are programmable.

20. The system of claim 19, wherein either or both of the first modulator and the second modulator comprise one or more of the following: a digital micromirror device, DMD; a liquid crystal spatial light modulator, LC-SLM.

21. The system of claim 1, comprising a detector arrangement configured to detect the output vectors.

22. The system of claim 21, wherein the source comprises a coherent source and the detector arrangement is configured to detect electric field amplitudes of light representing the output vectors using interference.

23. The system of claim 22, further comprising an optical bypass arrangement to allow a reference beam to bypass each of the modulators without being modulated.

24. The system of claim 21, wherein the source comprises an incoherent source and the detector arrangement is configured to detect intensities of light representing the output vectors.

25. The system of claim 1, wherein the system is configured to periodically switch the first modulator to encode different pluralities of input vectors in the rows of the first matrix.

26. The system of claim 1, comprising:
a third modulator comprising rows and columns of third modulator elements and configured to spatially modulate light received from the second modulator, wherein the third modulator is configured to encode values of a third matrix in the rows and columns of the third modulator elements; and
a further light-summing optical arrangement configured to converge light output from each column of third modulator elements to encode a plurality of further output vectors representing the results of vector-matrix multiplication between respective output vectors from the second modulator and the third matrix encoded by the third modulator.

27. An optical multiplication system, comprising:
a light input arrangement;
a first modulator comprising rows and columns of first modulator elements and configured to spatially modulate light received from the light input arrangement, wherein the first modulator is configured to encode values of a first matrix in the rows and columns of the first modulator elements, the first matrix defining a plurality of input vectors each corresponding to a respective row of the first matrix;
a second modulator comprising rows and columns of second modulator elements and configured to spatially modulate light received from the first modulator, wherein the second modulator is configured to encode values of a second matrix in the rows and columns of the second modulator elements;
a light-summing optical arrangement configured to converge light output from each row of second modulator elements to encode a plurality of output vectors representing the results of vector-matrix multiplication between a respective plurality of the input vectors and the second matrix;
a third modulator comprising rows and columns of third modulator elements and configured to spatially modulate light received from the second modulator, wherein the third modulator is configured to encode values of a third matrix in the rows and columns of the third modulator elements; and
a further light-summing optical arrangement configured to converge light output from each column of third modulator elements to encode a plurality of further output vectors representing the results of vector-matrix multiplication between respective output vectors from the second modulator and the third matrix encoded by the third modulator.

28. The system of claim 27, wherein the combination of the further output vectors represents the result of multiplication between the first matrix, second matrix, and third matrix.

29. The system of claim 28, configured such that one of the first modulator, second modulator and third modulator is set to encode a unity matrix such that the combination of the further output vectors represents a matrix-matrix multiplication between the two of the first modulator, second modulator and third modulator that have not been set to encode the unity matrix.

30. A method of performing optical multiplication, comprising:
using a deflector to direct light from a source to illuminate a selected row or selected rows of first modulator elements of a first modulator;
using the first modulator to spatially modulate light received from the deflector, wherein the first modulator encodes values of a first matrix in the rows and columns of the first modulator elements, the first matrix defining a plurality of input vectors each corresponding to a respective row of the first matrix;
using a second modulator comprising rows and columns of second modulator elements to spatially modulate light received from the first modulator, wherein the second modulator encodes values of a second matrix in the rows and columns of the second modulator elements; and
converging light output from each row of second modulator elements to encode a plurality of output vectors representing the results of vector-matrix multiplication between a respective plurality of the input vectors and the second matrix.

31. A method of performing optical multiplication, comprising:
using a first modulator comprising rows and columns of first modulator elements to spatially modulate light received from a light input arrangement, wherein the first modulator encodes values of a first matrix in the rows and columns of the first modulator elements, the first matrix defining a plurality of input vectors each corresponding to a respective row of the first matrix;
using a second modulator comprising rows and columns of second modulator elements to spatially modulate light received from the first modulator, wherein the second modulator is configured to encode values of a second matrix in the rows and columns of the second modulator elements;
converging light output from each row of second modulator elements to encode a plurality of output vectors representing the results of vector-matrix multiplication between a respective plurality of the input vectors and the second matrix;
using a third modulator comprising rows and columns of third modulator elements to spatially modulate light received from the second modulator, wherein the third modulator encodes values of a third matrix in the rows and columns of the third modulator elements; and
converging light output from each column of third modulator elements to encode a plurality of further output vectors representing the results of vector-matrix multiplication between respective output vectors from the second modulator and the third matrix encoded by the third modulator.
